(19) United States
(12) Patent Application Publication
(10) Pub. No.: US 2008/0073553 A1
(43) Pub. Date: Mar. 27, 2008

(54) ION BEAM PROFILER

(75) Inventors: Julian G. Blake, Gloucester, MA (US); Steven Richards, Georgetown, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: IBIS TECHNOLOGY CORPORATION, Danvers, MA (US)

(21) Appl. No.: 11/674,447

(22) Filed: Feb. 13, 2007

Related U.S. Application Data
(60) Provisional application No. 60/773,246, filed on Feb. 13, 2006.

(51) Int. Cl. G01K 1/08

(52) U.S. Cl. 250/398

(57) ABSTRACT

In one aspect, an ion beam profiler for use in an ion implanter is disclosed that includes a Faraday cup disposed in an end-station of the ion implanter in a path of an ion beam traveling from a source to the end-station. The Faraday cup comprises an aperture that is adapted to allow passage of a cross-sectional slices of the beam. An array of ion detectors is disposed behind the Faraday cup in substantial register with the aperture so as to receive different slices of the beam as the beam is scanned across the aperture. The bean profiler further comprises an analyzer that is coupled to the detector array for analyzing detector signals generated in response to ion impingement so as to compute a two-dimensional cross-sectional profile of the beam.

### RELATED APPLICATION

The present invention claims priority to a provisional application entitled “ION Beam Profiler,” filed on Feb. 13, 2006 and having a Ser. No. 60/773,246. This provisional application is herein incorporated by reference in its entirety.

### BACKGROUND

The present invention relates generally to devices for measuring the profile of an ion beam, and more particularly, to such devices that can be incorporated in an ion implantation apparatus.

A variety of approaches for measuring the cross-sectional profile of an ion beam are known. For example, in one approach, a two-dimensional array of electrodes, commonly referred to as a “microfaraday,” is exposed to an ion beam. The current generated by each electrode in response to ion impingement is measured so as to obtain information regarding the two-dimensional cross-sectional intensity profile of the beam. In another approach, an electrode (or a plurality of electrodes) is scanned across the beam so as to provide a one-dimensional profile (or a two-dimensional profile when more than one electrode is utilized) of the beam.

Such conventional beam-profiling techniques, however, suffer from a number of shortcomings. For example, the use of such techniques typically requires complex systems for cooling the electrodes. In fact, the difficulties involved in cooling the electrodes can render the use of such techniques for profiling high intensity ion beams (e.g., a beam power of 10 kW or more) impractical.

Accordingly, there is a need for enhanced ion beam profilers that are suitable for measuring the cross-sectional profiles of high intensity ion beams.

### SUMMARY

In one aspect, the present invention provides a beam profiler for use in an ion implanter, which includes an array of ion detectors disposed in an end-station of an ion implanter in a path of an ion beam. The detector array is adapted to receive different cross-sectional slices of the beam as the beam is scanned. The profiler further includes an analyzer in communication with the array to operate on detector signals generated in response to ion impingement so as to compute a cross-sectional intensity profile of the beam.

In a related aspect, the analyzer can temporally correlate the detector signals to the scanning of the beam so as to generate the beam's intensity profile. The analyzer can employ the detector signals at a given time to compute a profile of a beam portion impinging on the detectors at that time. The analyzer can then combine a plurality of profiles corresponding to different beam portions to compute a two-dimensional cross-sectional profile of the beam.

In another aspect, the detector array comprises a linear array of detectors disposed along a selected direction in the end-station. In some embodiments, the direction along which the detector array is disposed is substantially orthogonal to the direction along which the ion beam is scanned.

In another aspect, the above beam profiler further comprises a Faraday cup disposed in the end-station in the path of the ion beam, where the Faraday cup comprises an aperture in substantial register with the array such that a portion of the beam passes through the aperture to impinge on the array.

In a related aspect, the aperture has a height that is at least as large as the maximum vertical dimension (e.g., diameter) of the beam, and a width in a range of about 0.5 mm to about 2 mm. In many cases, the aperture limits the beam power incident on the array at a given time to less than about 1 kW, thereby minimizing the heat load on the detectors.

In another aspect, the beam profiler includes a cooled block for housing the detectors. For example, the block can include one or more passageways to permit the flow of a cooling fluid (e.g., water).

In other aspects, an ion beam profiler for use in an ion implanter is disclosed that includes a Faraday cup disposed in an end-station of the ion implanter in a path of an ion beam traveling from a source to the end-station. The Faraday cup comprises an aperture that is adapted to allow passage of cross-sectional slices of the beam. An array of ion detectors is disposed behind the Faraday cup in substantial register with the aperture so as to receive different slices of the beam as the beam is scanned across the aperture. The bean profiler further comprises an analyzer that is coupled to the detector array for analyzing detector signals generated in response to ion impingement so as to compute a two-dimensional cross-sectional profile of the beam.

In a related aspect, in the above beam profiler, the analyzer correlates the time dependence of the detectors signals with scanned positions of the beam for computing the cross-sectional profile.

In another aspect, the array of ion detectors is thermally coupled to a block having passageways for flowing a coolant therethrough. Each ion detector can include a conductive electrode for generating a current in response to impingement of ions thereon. In some embodiments, the current generated by the detectors is routed, via one or more electrically conductive paths, to the Faraday cup.

Further understanding of the invention can be obtained by reference to the following detailed description in conjunction with the drawings, which are described briefly below.

### BRIEF DESCRIPTION OF THE DRAWINGS

FIG. 1 schematically depicts an ion implanter in which a beam profiler in accordance with one embodiment of the invention is incorporated,

FIG. 2A is a schematic side view of a faraday cup utilized in the ion implanter of FIG. 1 having an aperture that allows passage of cross-sectional slices of an ion beam to the beam profiler,

FIG. 2B is a schematic top view of the faraday cup depicted in FIG. 2A,

FIG. 3 schematically illustrates a beam profiler in accordance with one embodiment of the invention comprising an array of ion detectors and an analyzer,

FIG. 4 schematically depicts some components of the analyzer shown in FIG. 3,

FIG. 5 schematically depicts an array of detectors of a beam profiler according to one embodiment of the invention, which is mounted in a cooled block, and

FIG. 6 schematically illustrates a few detector elements of the array shown in FIG. 5.

### DETAILED DESCRIPTION

The present invention generally provides a beam profiler for use in an ion beam implanter. In many embodiments, the beam profiler includes an array of ion detectors that sample different cross-sectional slices of an ion beam over time as the beam is scanned across the array. An analyzer, which is in communication with the detector array, receives information regarding the intensity of the sampled slices, and utilizes this information to compute a cross-sectional intensity of the ion beam.

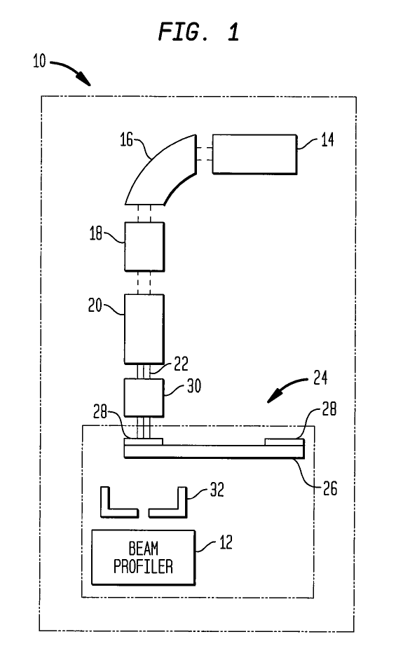

By way of example, FIG. 1 schematically depicts an ion beam implanter 10 in which an ion beam profiler 12 according to an embodiment of the invention is incorporated. The ion implanter 10 (herein also referred to as an ion implantation system) includes an ion source 14 that generates ions, and an ion analyzer 16, such as a magnetic analyzer, that selects appropriately charged ions. An accelerator 18 accelerates the selected ions to a desired energy, e.g., about 200 keV, and the beam forming device 20 shapes the accelerated ions to an ion beam 22 having a cross-sectional shape and intensity profile.

The exemplary implanter 10 further includes an end-station 24 in which a rotating wafer holder 26 is disposed to which a plurality of wafers 28 can be mounted. A drive mechanism (not shown) can rotate the wafer holder to place the wafers in the path of the ion beam. Further, the ion implanter can include an ion scanner 30, such as those known in the art, for scanning the ion beam in a selected direction across the wafers. The combined scanning of the beam and rotation of the wafers by the wafer holder allows implantation of ions over a two-dimensional span of the wafer—typically within a depth of the wafer.

With continued reference to FIG. 1, a Faraday cup 32 is also disposed in the end station 24 that can capture ions not intercepted by the wafers. Additional details regarding various examples of Faraday cups suitable for use in the ion implanter 10 can be found in U.S. Pat. No. 6,815,696 entitled “Beam Stop For Use In An Ion Implantation System,” which is herein incorporated by reference.

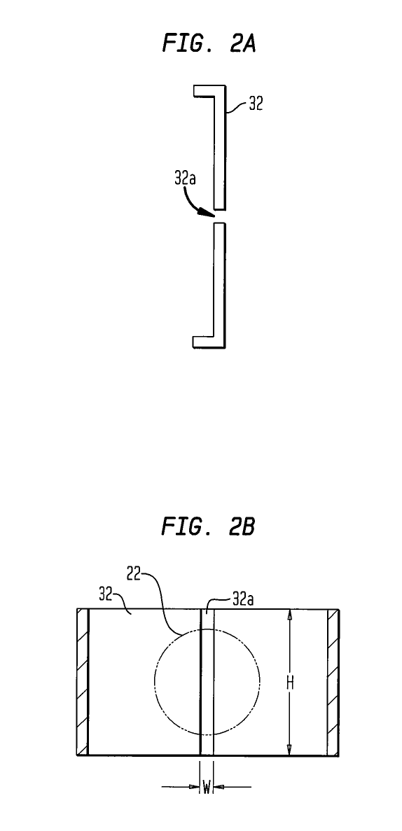

The ion beam profiler 12 according to one embodiment of the invention, which is disposed behind the faraday cup 32, allows measuring a cross-sectional intensity profile of the ion beam in a manner discussed in more detail below. As shown schematically in FIGS. 2A and 2B, in this exemplary embodiment, the faraday cup 32 includes an aperture 32a that allows a portion of the beam (that is, a cross-sectional slice of the beam) to be incident on the ion profiler 12. In this embodiment, the aperture 32a is elongated along a direction substantially perpendicular to the direction in which the beam is scanned by the scanner 30. For ease of discussion, the direction in which the beam is scanned is herein referred to as “horizontal direction,” and the direction along which the elongated dimension of the aperture is disposed is herein referred to as “vertical direction.” The aperture 32a can have a height (H) greater than a maximum vertical dimension of the beam and a width (W) in a range of about 0.5 millimeter (mm) to about 2 mm. As the beam 22 (shown with dashed lines in FIG. 2B) is scanned horizontally across the aperture 32a, different vertical cross-sectional slices of the beam pass through the aperture to reach the beam profiler 12.

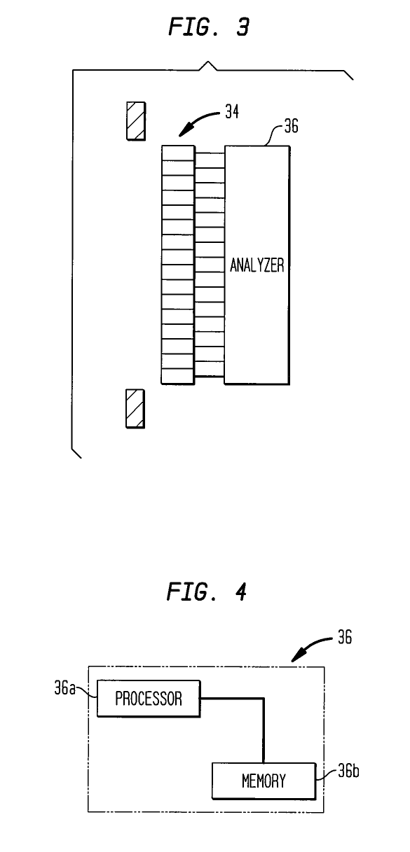

With reference to FIG. 3, the beam profiler 12 includes a one-dimensional array of ion detectors 34, which is disposed in substantial register with the aperture 32a to receive different vertical cross-sectional slices of the beam as it is scanned across the aperture. For each such cross-sectional slice, the detectors 34 detect the intensity of different portions of that slice to generate information regarding the vertical profile of that portion of the beam. More specifically, each detector generates a current in response to incidence of ions thereon, where the current is proportional to the number of incident ions. In this embodiment, the current generated by each detector flows to the faraday cup 32, e.g., via a conductive path (not shown), to allow measuring the total current generated by the detectors. As the beam is scanned across the aperture, the detectors 34 generate information regarding different the vertical profile of different slices of the beam.

The beam profiler 12 further includes an analyzer 36 that is in communication with the array of detectors to receive information regarding the vertical intensity profiles of different vertical slices of the beam. The analyzer 36 utilizes this information to compute a two-dimensional profile of the beam. By way of example, as shown schematically in FIG. 4, in this embodiment, the analyzer 36 can include a processor 36a and associated memory 36b. In some embodiments, the memory 36b can store the information regarding vertical profiles of different cross-sectional slices of the beam, and the processor 36a can utilize this information to generate, e.g., by executing pre-loaded instructions, the two-dimensional profile of the beam. By way of example, the analyzer can temporally correlate the scanning of the beam to the detectors signals so as to generate a two-dimensional profile of the beam, e.g., by combining the vertical profiles of different cross-sectional slices of the beam.

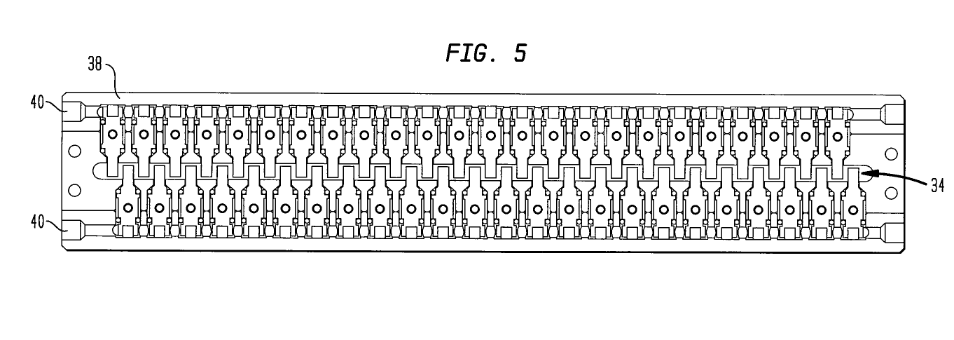

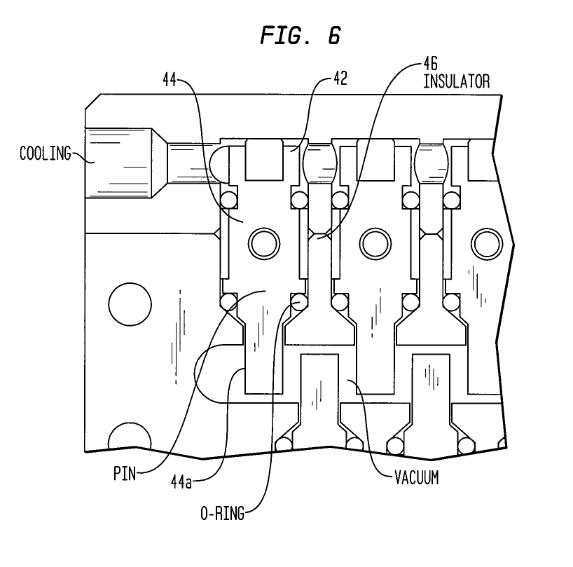

As shown schematically in FIG. 5, in this embodiment, the detector array 34 is mounted in a block 38 that includes channels 40 through which a cooling fluid, e.g., water, can flow so as to extract heat from the detectors. With reference to FIG. 6, each detector in the array, such as exemplary detector 42, includes an electrically conductive electrode 44, a portion of which 44a is disposed within an evacuated channel to face the ion beam. A plurality of electrically insulating elements, such as insulator 46, separate adjacent detecting elements from one another. Each conductive electrode generates a current in response to impingement of ions thereon. The current generated by each electrode can be amplified and detected in a manner known in the art to provide a measure of the intensity of ions striking that electrode.

In operation, prior to exposing wafers to an ion beam, the beam profiler can be utilized to obtain a cross-sectional profile of the beam. For example, the wafer holder can rotated to be out of the beam's path so as to allow the entire beam strike the faraday cup. The beam can be horizontally scanned across the aperture in the faraday cup, and the time-resolved data regarding the vertical intensity profiles of different cross-sectional slices of the beam can be analyzed to determine a two-dimensional cross-sectional profile of the beam. Once an acceptable cross-sectional profile is observed, the wafer holder can be rotated so as to expose wafers mounted thereon to the beam.

A beam profiler according to the teachings of the invention provides a number of advantages. For example, in the above embodiment, at any given time, only a small fraction of the beam (e.g., a fraction passing through the aperture in the Faraday cup) strikes the detectors. This advantageously ameliorates heating of the detectors as a result of ion bombardment, thus facilitating cooling of the detectors.

Those having ordinary skill in the art will appreciate that various changes can be made to the above embodiments without departing from the scope of the invention.

What is claimed is:

1. An ion beam profiler for use in an ion implanter, comprising
an array of ion detectors disposed in an end-station of an ion implanter in a path of an ion beam, said array adapted to receive different cross-sectional slices of the beam as the beam is scanned,
an analyzer in communication with the array to operate on detector signals generated in response to ion impingement so as to compute a cross-sectional intensity profile of the beam.

2. The beam profiler of claim 1, wherein said analyzer temporally correlates said detector signals to the scanning of the beam so as to generate the beam's intensity profile.

3. The beam profiler of claim 2, wherein said analyzer utilizes the detector signals at a given time to compute a profile of a beam portion impinging on the detectors at that time.

4. The beam profiler of claim 3, wherein said analyzer combines a plurality of profiles of different beam portions to compute a cross-sectional profile of the beam.

5. The beam profiler of claim 1, wherein said array comprises a linear array of detectors disposed along a selected direction in the end-station.

6. The beam profiler of claim 5, wherein the array direction is substantially orthogonal to a direction of the beam scan.

7. The beam profiler of claim 1, further comprising a faraday cup disposed in said end-station in the path of the beam, said faraday cup comprising an aperture in substantial register with said array such that a portion of the beam passes through said aperture to impinge on the array.

8. The beam profiler of claim 7, wherein said aperture has a height that is at least as large as a maximum vertical dimension of a cross-section of the beam.

9. The beam profiler of claim 8, wherein said aperture has a width in a range of about 0.5 to about 2 mm.

10. The beam profiler of claim 7, wherein said aperture limits a beam power incident on the array at a given time to less than about 1 kW.

11. The beam profiler of claim 1, further comprising a cooled block for housing said detectors.

12. The beam profiler of claim 11, wherein said block comprises one or more passageways for flowing a cooling fluid therethrough.

13. The beam profiler of claim 11, wherein the ion beam has a power in a range of about 10 kW to about 30 kW.

14. The beam profiler of claim 11, wherein the ion beam comprises ions having energies in a range of about 50 to about 250 keV.

15. An ion beam profiler for use in an ion implanter, comprising
a faraday cup disposed in an end-station of an ion implanter in a path of an ion beam traveling from a source to the end-station, said faraday cup comprising an aperture adapted to allow passage of cross-sectional slices of the beam,
an array of ion detectors disposed behind the faraday cup in substantial register with said aperture so as to receive different slices of the beam as the beam is scanned across the aperture, and
an analyzer coupled to said detector array for analyzing detector signals generated in response to ion impingement to compute a two-dimensional cross-sectional profile of the beam.

16. The beam profiler of claim 15, wherein said analyzer correlates a time dependence of the detectors signals with scanned position of the beam for computing said cross-sectional profile.

17. The beam profiler of claim 15, wherein said aperture has a height greater than a maximum linear dimension of the beam's cross-section.

18. The beam profiler of claim 17, wherein said aperture has a width in a range of about 0.5 mm to about 2 mm.

19. The beam profiler of claim 15, wherein said array of ion detectors is thermally coupled to a block having passageways for flowing a coolant therethrough.

20. The beam profiler of claim 15, wherein at least one of said ion detectors comprises a conductive electrode generating a current in response to impingement of ions thereon.

21. The beam profiler of claim 20, wherein the current generated by the conductive electrode flows to the faraday cup.
